(19) United States
(12) Patent Application Publication
(10) Pub. No.: US 2009/0237653 A1
(43) Pub. Date: Sep. 24, 2009

(54) DEVICE FOR RECORDING A NUMBER OF IMAGES OF DISK-SHAPED OBJECTS

(75) Inventors: Markus Schnitzlein, Radolfszell (DE); Thomas Iffland, Jena (DE)

Correspondence Address: Davidson, Davidson & Kappel, LLC, 485 7th Avenue, 14th Floor, New York, NY, 10018, US

(73) Assignees: Chromasens GmbH, Konstanz (DE); VISTEC Semiconductor Systems GmbH, Wetzlar (DE)

(21) Appl. No.: 11/992,692

(22) PCT Filed: Sep. 29, 2006
(86) PCT No.: PCT/EP2006/066887

§ 371 Date: Mar. 27, 2008

(30) Foreign Application Priority Data
Oct. 1, 2005 (DE) 10 2005 047 281.8
Mar. 2, 2006 (DE) 10 2006 009 593.6

(51) Int. Cl. G01N 21/88

(52) U.S. Cl. 356/237.2

(57) ABSTRACT

A device for recording a number of images of disk-shaped objects (6), which is provided with at least two lighting device (8), which are designed so that the light exiting the lighting devices (8) is spectrally variable. A single recording device (12) is arranged in relation to the disk-shaped object so that the recording device (12) simultaneously records a number of spectrally variable images of the disk-shaped object (6).

The present invention relates to a device for recording a plurality of images of disk-shaped objects. In particular, the present invention relates to a device for recording a plurality of images of disk-shaped objects, which includes at least two illuminating devices whose design is such that the light emanating therefrom varies spectrally.

The German Patent Application DE 103 37 727 A1 describes a method and a device for inspecting the optical quality of objects having preferably a circular circumferential rim, the light being directed to the rim of the object, and the light emanating from the object as the result of reflection, refraction and/or diffraction being detected by a measuring device. Defects on and/or in the object are ascertained on the basis of the detected image signals.

The German Patent Application DE 103 30 006 A1 discusses a device for inspecting a wafer. At least two incident-light illuminating devices are provided, which each emit an illuminating light beam that strikes the surface of a wafer to be inspected at oblique incidence and defines an illumination axis. An image-acquisition device for capturing an image of the surface in a dark-field configuration, as well as a wafer recording device for recording the wafer at a predefinable orientation, on whose surface linearly extending structures are formed. It is a characteristic of the device that the illumination axes are oriented orthogonally to each other, and its design is such that a projection of the particular illumination axis onto the surface of the wafer is oriented orthogonally to the linear structures in question on the surface of the wafer.

The German Patent Application DE 102 39 548 A1 describes a device and a method for inspecting an object which provides for a bright-field illumination beam path of a bright-field light source formed with respect to an imaging optics, and for a dark-field illumination beam path of a dark-field light source formed with respect to the imaging optics, an image of the object being able to be formed by the imaging optics on at least one detector, and the object being simultaneously illuminated by the two light sources. To simultaneously detect bright-field and dark-field images without entailing costly filter operations, the device and, respectively, the method according to the present invention for inspecting an object are conceived in such a way that the light used for dark-field illumination is pulsed, and the pulse intensity of the light used for dark-field illumination is greater by at least one order of magnitude than the intensity, in terms of one pulse interval, of the continuous light used for bright-field illumination.

The German Patent Application DE 199 46 520 A1 describes a device and a method for discovering and for classifying surface errors of an incoming band material. To that end, an illuminating device is provided for producing an illumination surface area, and a camera system is used for recording an image of the inspection surface. A computational and control device includes at least one matrix array camera. The inspection area-array image is subdivided into at least two separately evaluable image sections.

The German Patent Application DE 100 30 772 A1. The present invention relates to an arrangement, as well as to a method for illumination, in particular for incident-light illumination in the context of microscopes. An annular carrier for accommodating illumination means is oriented about the optical axis. In accordance with the present invention, the illumination means are light-emitting semiconductor diodes (LED) located in the annular carrier, the main beam direction of the semiconductor diodes, which have a relatively small angle of radiation, being oriented, respectively inclined towards the optical axis of the system. As diodes, white-light LEDs are used, which are preferably fixed in at least two concentric annular rows within the annular carrier. Adjacent LEDs are interconnected into groups and are operated via a controllable constant current source.

It is an object of the present invention to devise a device for simultaneously recording a plurality of images of a disk-shaped substrate from one single location.

The objective is achieved by a device having the features set forth in claim 1.

It is advantageous for one single recording device to be positioned relative to the disk-shaped object in such a way that the recording device is able to simultaneously record a plurality of spectrally different images of the disk-shaped object.

The two illuminating devices are positioned in relation to the disk-shaped object in such a way that they illuminate one and the same region on the surface of the disk-shaped object. A first one of the two illuminating devices is positioned in the bright-field configuration relative to the illuminated region, and a second one of the two illuminating devices is positioned in the dark-field configuration.

The first illuminating device in the bright-field configuration includes a narrow-band blue illumination, and the second illuminating device in the dark-field configuration includes a narrow-band red illumination.

A recording device is provided which records the region on the surface of the disk-shaped object that is simultaneously illuminated by the illuminating devices. The recording device is a CCD color camera which is provided with pixels arranged in a planar or linear array. The individual pixels of the CCD color camera are provided with filter coatings, so that color channels are separately sensitive to red, blue or green light, and they register red, blue and, respectively, green light in each case in broad wavelength bands. The blue color channel registers a bright-field image, and the red color channel registers a dark-field image.

A third illuminating device may be provided, which illuminates the disk-shaped object with light of a wavelength that differs from the wavelengths of the first and the second illuminating device. The third illuminating device may emit green light. (The colors are freely combinable—blue bright field, red dark field or vice versa; likewise conceivable are combinations with green.)

Other advantageous embodiments of the present invention may be inferred from the dependent claims.

The subject matter of the present invention is schematically illustrated in the drawing and is described below with reference to the figures, in which:

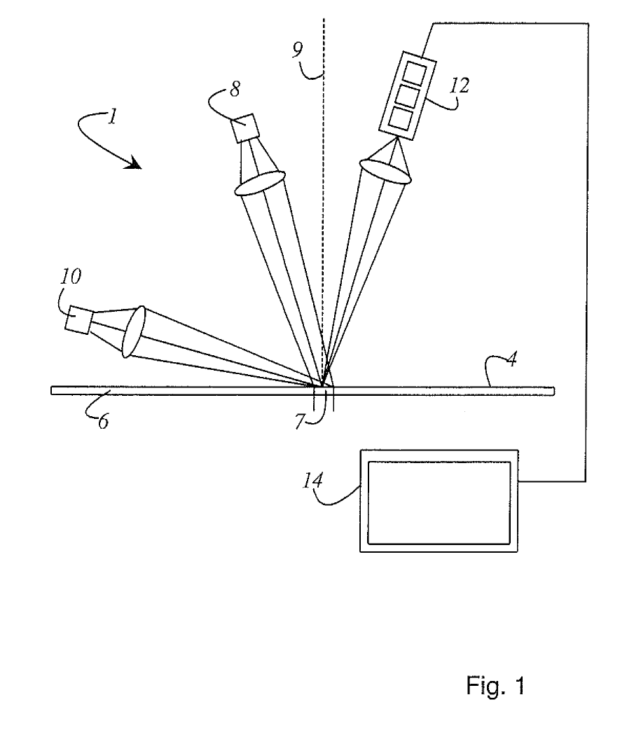

FIG. 1: is a schematic representation of the device for recording the surface of a disk-shaped object in accordance with the present invention;

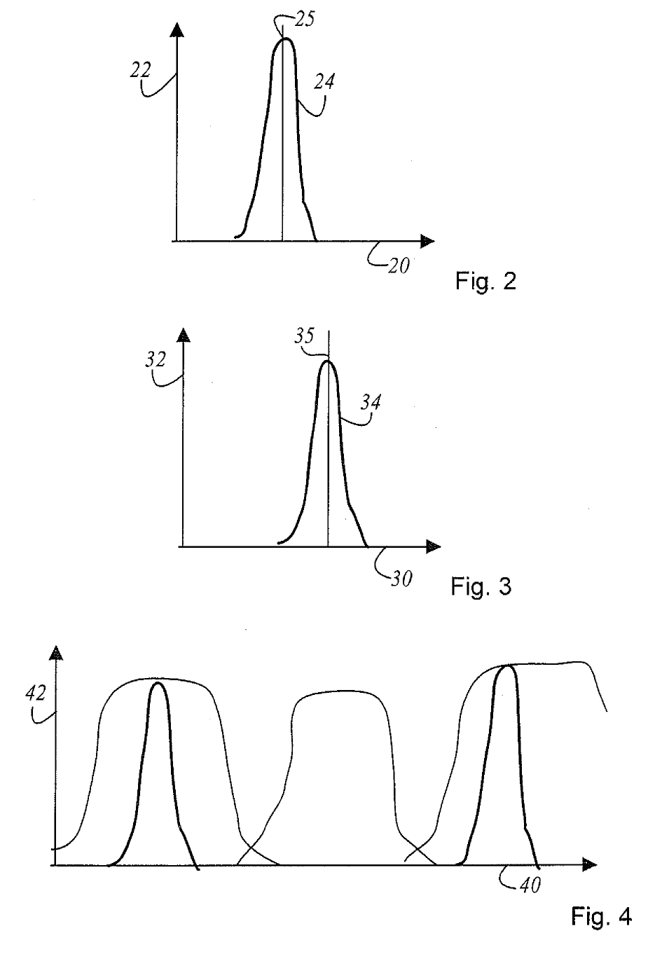

FIG. 2: is a schematic representation of the spectral distribution of the light from the first illuminating device;

FIG. 3: is a schematic representation of the spectral distribution of the light from the second illuminating device;

FIG. 4: is a schematic representation of the intensities registered by the recording device;

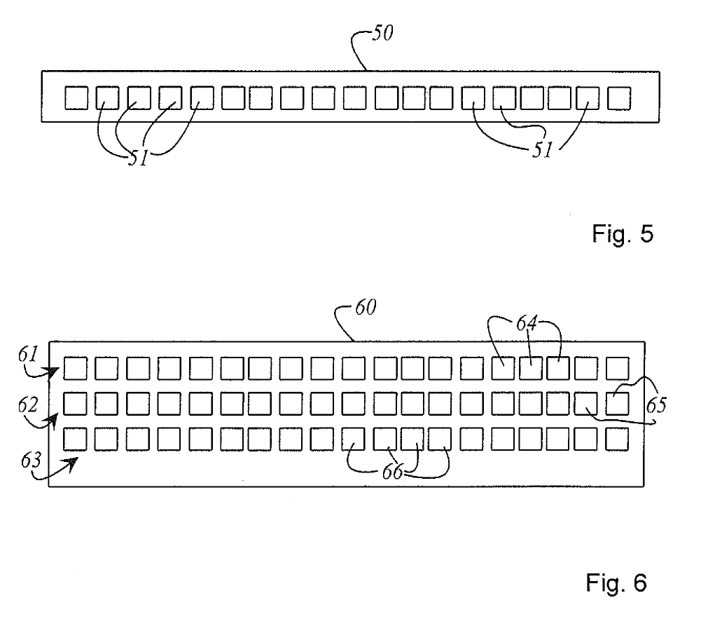

FIG. 5: is an enlarged representation of an illuminating device, the illuminating device being made up of a linear LED array;

FIG. 6: is an enlarged representation of the sensor of the recording device which is designed for simultaneously recording two spectrally different images.

FIG. 1 is a schematic representation of a device 1 for recording a surface 4 of a disk-shaped object 6 in accordance with the present invention. A plurality of images of one and the same region 7 of surface 4 of disk-shaped object 6 are simultaneously recorded. Device 1 includes at least one first illuminating device 8 for bright-field illumination and at least one second illuminating device 10 for dark-field illumination for disk-shaped object 6. The described device 1 is suited for imaging raised and/or embedded structures on flat or curved surfaces. Disk-shaped objects 6 may be a wafer (front and/or rear side and/or rim), glass plates, panels, a flat-panel display or circuit boards, etc. In addition, device 1 is provided with a recording device 12 for capturing the light emanating from an illuminated region 7 of disk-shaped object 6. In one specific embodiment, first illuminating device 8 and second illuminating device 10 are designed as a linear LED array. First and second illuminating devices 8 and 10 may equally include a band emitter or at least one fluorescent tube. First illuminating device 8 in the bright-field configuration includes a narrow-band blue illumination. Second illuminating device 10 in the dark-field configuration includes a narrow-band red illumination. First illuminating device 8 for bright-field illumination is inclined at a small angle relative to a perpendicular line 9 on surface 4 of disk-shaped object 6. The light from first illuminating device 8 for bright-field illumination is reflected directly off of surface 4 of disk-shaped object 6 into recording device 12. In this specific embodiment, the light from first illuminating device 8 for bright-field illumination may be produced using a red linear LED array. Recording device 12 is a CCD color camera having pixels arranged in a planar or linear array. Recording device 12 communicates with an evaluation device 14 which separates the color channels accordingly and thus produces intensity-dependent images for each color channel.

FIG. 2 is a schematic representation of the spectral distribution of the light from first illuminating device 8. The wavelength is plotted on abscissa 20, and the intensity on ordinate 22. First illuminating device 8 emits red light in a narrow-band region 24. In this context, the narrow-band region has a width of approximately 30 nm. In one preferred specific embodiment, the narrow-band region has a maximum 25 at 630 nm.

FIG. 3 is a schematic representation of the spectral distribution of the light from second illuminating device 10. The wavelength is plotted on abscissa 30, and the intensity on ordinate 32. Second illuminating device 10 emits blue light in a narrow-band region 34. In this context, the narrow-band region has a width of approximately 30 nm. In one preferred specific embodiment, the narrow-band region has a maximum 35 at 450 nm.

It is self-evident to one skilled in the art that the regions or wavelengths indicated in the descriptions for FIGS. 2 and 3 merely represent one of a plurality of specific embodiments. One skilled in the art is free to select that spectral illumination which appears to be the most suitable approach for overcoming the imaging difficulty.

FIG. 4 is a schematic representation of the intensities registered by the. The CCD color camera has pixels arranged in a linear array that are sensitive to different spectral regions. Typically, three rows of pixels are provided, of which a first row is sensitive to red light, a second row to green light, and a third row to blue light. In FIG. 4, the wavelength is plotted on abscissa 40, and the registered intensity on ordinate 42. Recording device 12 registers a broader wavelength region than the narrow-band spectral illumination. The dark-field illumination is registered in the red spectral region, and the bright-field illumination in the blue spectral region.

FIG. 5 shows an enlarged representation of an illuminating device 50; in this specific embodiment, illuminating device 50 being made up of a plurality of LEDs 51. It is likewise conceivable that the illuminating devices include a band emitter or at least one fluorescent tube. Illuminating device 60 is at least as wide as the object to be examined.

FIG. 6 shows an enlarged representation of a sensor 60 of recording device 12. Sensor 60 is designed for simultaneously recording a bright-field image and a dark-field image of the disk-shaped object. The sensor includes a first row 61 having sensor elements 64 which are sensitive to red light, a second row 62 having sensor elements 65 which are sensitive to green light, and a third row 63 having sensor elements 66 which are sensitive to blue light. The sensitivity of the individual sensor elements may be achieved using appropriate filters, for example. The recording principle underlying recording device 12 may be expanded to include utilizing second row 62 having sensor elements 65 which are sensitive to green light (green channel) to acquire further information. One option is to illuminate the object with a green laser or a green LED in such a way that the deviation from the nominal position in the image of the green channel is used to determine the focal position or the tilt angle of the object.

1-16. (canceled)

17. A device for recording a plurality of images of disk-shaped objects, comprising:
at least two illuminating devices, light emanating from the illuminating devices varying; and
one single recording device positioned relative to the disk-shaped object to enable the recording device to simultaneously record a plurality of spectrally different images of the disk-shaped object.

18. The device as recited in claim 17, wherein the two illuminating devices are positioned in relation to the disk-shaped object in such a way that the two illuminating devices illuminate one same region on a surface of the disk-shaped object.

19. The device as recited in claim 18 wherein a first of the two illuminating devices is positioned in a bright-field configuration relative to the illuminated region; and a second of the two illuminating devices is positioned in a dark-field configuration.

20. The device as recited in claim 19, wherein the first illuminating device in the bright-field configuration includes a narrow-band blue illumination, and the second illuminating device in the dark-field configuration includes a narrow-band red illumination.

21. The device as recited in claim 20, wherein the red illumination includes a band emitter or at least one red fluorescent tube or red light-emitting diodes.

22. The device as recited in claim 20, wherein the blue illumination includes a band emitter or at least one blue fluorescent tube or blue light-emitting diodes.

23. The device as recited in claim 17, wherein the recording device records a region on the surface of the disk-shaped object simultaneously illuminated by the two illuminating devices.

24. The device as recited in claim 23, wherein the recording device is a CCD color camera having pixels arranged in a planar or linear array.

25. The device as recited in claim 24, wherein the individual pixels of the CCD color camera are provided with filter coatings, so that color channels are separately sensitive to red, blue or green light, and the color channels register red, blue and, respectively, green light in each case in broad wavelength bands.

26. The device as recited in claim 25 further comprising a further recording device separating the color channels accordingly and producing intensity-dependent images for each color channel.

27. The device as recited in claim 26, wherein the blue color channel registers a bright-field image, and the red color channel registers a dark-field image.

28. The device as recited in claim 27, wherein the green color channel can be used to acquire further information.

29. The device as recited in claim 28, wherein the at least two illuminating devices include a third illuminating device illuminating the disk-shaped object with light of a wavelength that differs from the wavelengths of a first and a second illuminating device of the at least two illuminating devices.

30. The device as recited in claim 29, wherein the third illuminating device is a laser or an LED which emits green light, the green light capable of being used to register a deviation from a nominal position.

31. The device as recited in claim 30, wherein the nominal position is a focal position or a tilt angle of the disk-shaped object.

32. The device as recited in claim 17 wherein first and second illuminating device of the at least two illuminating devices includes a linear illumination designed as a linear LED array.
